(19) United States
(12) Patent Application Publication
(10) Pub. No.: US 2004/0238764 A1
(43) Pub. Date: Dec. 2, 2004

(54) Optical moving amount detecting device, electronic equipment, and conveyance processing system

(76) Inventors: Akifumi Yagaguchi, Kashiba-shi (JP); Hisakazu Sugiyama, Takaraduka-shi (JP)

Correspondence Address: BIRCH STEWART KOLASCH & BIRCH, PO BOX 747, FALLS CHURCH, VA, 22040-0747, US

(21) Appl. No.: 10/829,364

(22) Filed: Apr. 22, 2004

(30) Foreign Application Priority Data
Apr. 25, 2003 (JP) P2003-121395

(51) Int. Cl. G02B 7/04; G01N 21/86

(52) U.S. Cl. 250/559.19; 250/559.29

(57) ABSTRACT

Light from a light emitter is made into a linear beam extending in parallel with a direction of movement of a detection object and the beam is cast on the detection object. A linear reflected beam that is the linear beam reflected from the detection object is made incident on a light receiver. Thus first output waveform signals from the light receiver at a first time point and second output waveform signals from the light receiver at a second time point are stored into a storage unit. A moving amount detecting unit detects an amount of shift between the first output waveform signals and the second output waveform signals and calculates a moving amount of the detection object on basis of the amount of shift. Thus an optical moving amount detecting device is provided that is capable of accurately measuring a moving amount of a detection object having smooth surfaces.

This Nonprovisional application claims priority under 35 U.S.C. §119(a) on Patent Application No. 2003-121395 filed in Japan on Apr. 25th 2003, the entire contents of which are hereby incorporated by reference.

### BACKGROUND OF THE INVENTION

The present invention relates to an optical moving amount detecting device for measuring a moving amount of an object such as paper form having a non-specular surface without contact, i.e., without marking or the like on the object, electronic equipment having the moving amount detecting device, and a conveyance processing system for conveying and processing an object while detecting a moving amount of the object with use of the moving amount detecting device.

For electronic equipment such as printer and copying machine for processing while conveying a paper form as a detection object, a roller-type moving amount measuring devices has conventionally been used as a device for measuring a moving amount of the paper form. When the detection object is conveyed with rotation of an insertion roller, the moving amount measuring device detects the moving amount on basis of an amount of rotation of the roller and a diameter of the roller.

The roller-type moving amount measuring device, however, is based on a premise that slip never occurs between the roller and the detection object. If a slip occurs between the roller and the detection object in the conveyance, therefore, an error is produced in an amount of conveyance of the detection object, so that processing cannot be applied to specified positions on the detection object. In an example of a printer, printing is then done in wrong positions on a paper form instead of being done in specified positions.

In a printer that prints images such as photographs at high resolution, particularly, control of printing processes with measurement of a moving amount of a paper form being conveyed without interference in conveyance of the paper form is required for printing in specified positions. Thus some moving amount measuring devices measure a moving amount of a detection object, independently of means for conveying the detection object.

As such a moving amount measuring device, there is a moving amount measuring device for paper-like object that is disclosed in JP 09-318320 A and that optically measures a moving amount without contact with use of speckle pattern. The moving amount measuring device for paper-like object makes use of a phenomenon in which irradiation of an object with coherent light such as laser causes interference resulting from scattering of reflected light according to a roughness of a surface of the object and thus produces a spotted pattern referred to as speckle pattern as shown in FIG. 14.

FIG. 15 is a diagram illustrating a configuration of the moving amount measuring device for paper-like object. A rough surface of a bill 9 as a paper-like object of which at least one surface is rough and opaque is irradiated with coherent light 2 by light irradiation means 1 composed of laser diode or the like. Then reflected light 3 from the rough surface of the bill 9 is received and converted into electric picture signal by an imaging device 4. An output of the imaging device 4 at a first time point is stored into a first storage 5, and an output of the imaging device 4 at a second time point when a predetermined period of time has elapsed since the first time point is stored into a second storage 6. Then an extracting section 7a of a picture processing unit 7 extracts a frequency spectrum from a composite picture of a picture stored in the first storage 5 and of a picture stored in the second storage 6, a detecting section 7b detects frequency peaks of the extracted frequency spectrum, and a calculating section 7c calculates an interval Δdx between the detected frequency peaks and thereby determines a moving amount of the bill 2. Then processing of the bill 9 is carried out by a controller 8 on basis of the moving amount Δdx outputted from the calculating section 7c.

Among other methods of detecting a moving amount are a space filter method in which a moving object is irradiated with light from a light source such as LED (light emitting diode) and in which a relative moving amount of the moving object is determined on basis of output waveform signal from a spatial filter that extracts signal of a specified spatial frequency component from reflected light from the moving object, and a method in which a moving amount of an object is detected by frame processing based on image sensor pictures that is used in optical mice.

The conventional moving amount measuring device for paper-like object that is disclosed in JP 09-318320 A, however, has following problems. That is, pictures of the speckle pattern are captured with use of an image sensor as the imaging device 4, and various calculations are performed by the picture processing unit 7. Accordingly, there are required an enormous amount of information, complicated calculations, and a large-scale and expensive device. On condition that an object such as OHP (overhead projector) sheet having comparatively smooth surfaces and a high regular reflectance is used as the paper-like object, a problem is caused in that the object is extremely difficult to detect.

In the space filter method, the calculation of the spatial frequency component and the like is so complicated that the device may be made expensive. Besides, there is a problem in that an object having a smooth surface decreases the output and thus makes it difficult to process the picture signal. The optical mice cause problems in that processing of picture signal on a frame-by-frame basis is complicated and in that it is difficult to detect a moving amount of an object having smooth surfaces which results in weak output waveform signal.

### SUMMARY OF THE INVENTION

Therefore, an object of the present invention is to provide an optical moving amount detecting device that is small in size and inexpensive and that is capable of accurately measuring a moving amount of a detection object having smooth surfaces, and to provide electronic equipment having the same.

Another object of the invention is to provide a conveyance processing system that is capable of accurately measuring a position of a detection object, conveying the detection object to a specified position, and performing specified processing.

In order to achieve the objects, an optical moving amount detecting device of the invention comprises:

a light emitter,

a light receiver,

a first optical system for making light from the light emitter into a linear beam extending in parallel with a direction of movement of a detection object and casting the linear beam on the detection object,

a second optical system by which a linear reflected beam that is the linear beam reflected from the detection object is made incident on the light receiver,

a storage unit for storing first output waveform signals that are outputted from the light receiver receiving the linear reflected beam at a first time point and that represent an output distribution of the linear reflected beam along a longitudinal direction thereof and storing second output waveform signals that are outputted from the light receiver receiving the linear reflected beam at a second time point and that represent an output distribution of the linear reflected beam along the longitudinal direction thereof, and

a moving amount detecting unit for detecting an amount of shift between the first output waveform signals and the second output waveform signals in the longitudinal direction of the linear reflected beams and detecting a moving amount of the detection object on basis of the amount of shift.

In accordance with the optical moving amount detecting device of the invention, at the first time point, light from the light emitter is made into the linear beam extending in parallel with the direction of movement of the detection object and the beam is cast on the detection object. The linear reflected beam reflected from the detection object is made incident on the light receiver, and then the first output waveform signals outputted from the light receiver are stored into the storage unit. At the second time point after that, similarly, light from the light emitter is made into the linear beam, which is cast on the detection object. The linear reflected beam reflected from the detection object is made incident on the light receiver, and then the second output waveform signals outputted from the light receiver are stored into the storage unit. The moving amount detecting unit detects the amount of shift between the first output waveform signals and the second output waveform signals in the longitudinal direction of the linear reflected beams and detects the moving amount of the detection object on basis of the amount of shift.

In this manner, the moving amount of the detection object is detected on basis of the output waveform signals from the light receiver that represent surface conditions (conditions of unevenness) of the detection object. Even if the detection object has comparatively smooth surfaces, therefore, a moving amount of the detection object can accurately be detected. Besides, signal processing can easily be performed by the moving amount detecting unit, and a number of components of the device is small. Furthermore, a specified range can be measured with use of the linear beam, and any additional driving mechanisms are not required for moving irradiation light. As a result, the optical moving amount detecting device is obtained that is small in shape and that can be produced at low cost.

In an embodiment of the optical moving amount detecting device, the light emitter is composed of a plurality of semiconductor laser devices disposed linearly.

In accordance with the optical moving amount detecting device of the embodiment, a laser beam from the semiconductor laser devices is efficiently condensed by lenses forming the first optical system and the second optical system, and a quantity of light required for photoelectric exchange performed by the light receiver is sufficiently obtained from reflected light from the detection object. Besides, the device is further miniaturized with use of the semiconductor laser devices for the light emitter.

In an embodiment of the optical moving amount detecting device, a deflector for deflecting the linear reflected beam from the detection object is provided between the first optical system and the detection object.

In accordance with the optical moving amount detecting device of the embodiment, the light emitter and the light receiver are prevented from overlapping each other on condition that an optical axis of the beam on casting side and an optical axis of the beam on reflection side are identical. Thus an output can easily be gained and the device can be miniaturized. Besides, the optical axes can be made generally perpendicular to the detection object, thus the output can be gained further easily, and detection accuracy can be improved.

In an embodiment of the optical moving amount detecting device, the moving amount detecting unit comprises a waveform correcting section for multiplying parts of the first output waveform signals and of the second output waveform signals by a plurality of coefficients according to a light intensity distribution of the linear beam with respect to a longitudinal direction of the linear beams and thus correcting the light intensity distribution of the linear beam with respect to the longitudinal direction.

In accordance with the optical moving amount detecting device of the embodiment, intensities of the irradiation light can be corrected by the moving amount detecting unit on a side of the light receiver without being made uniform with respect to the directions of the length. Thus an accuracy in the detection of the amount of shift can be improved and a structure of the light emitter can be simplified.

In an embodiment of the optical moving amount detecting device, the moving amount detecting unit comprises a moving amount calculating section for determining correlation coefficients between first output waveform partial signals that are outputted at the first time point from a first partial area corresponding to part of an image of the linear reflected beam on the light receiver with respect to the longitudinal direction and a plurality of sets of second output waveform partial signals that are outputted at the second time point from a plurality of partial areas corresponding to a plurality of parts of an image of the linear reflected beam on the light receiver, determining a second partial area that results in a highest correlation coefficient at the second time point, and calculating the moving amount of the detection object on basis of an amount of shift between the first partial area and the second partial area.

In accordance with the optical moving amount detecting device of the embodiment, the amount of shift is obtained on basis of correlation coefficients between the first output waveform signals and the second output waveform signals. Thus the amount of shift can accurately be detected even if waveforms of the first and second output waveform signals are not thoroughly identical because of an error in the detection.

In an embodiment of the optical moving amount detecting device, a size of the first partial area of the light receiver is such that the first output waveform partial signals outputted from the first partial area can be discriminated from signals outputted at the first time point from areas other than the first partial area in the light receiver and wherein a size of a whole area of the light receiver is not smaller than a sum of the size of the first partial area and of a moving amount of an image of the linear reflected beam which amount corresponds to a predetermined moving amount of the detection object. In the case that the optical moving amount detecting device of the invention is used for equipment such as printer that conveys a detection object (a paper form) and performs processing on the object, the predetermined moving amount of the detection object refers to a feed of the detection object in a conveying section of the equipment which feed has been preset according to a size of the detection object, a position for the processing on the detection object, and the like.

In accordance with the optical moving amount detecting device of the embodiment, a number of output values (a number of comparison data) forming the first output waveform partial signals that are used for the calculation of the correlation coefficients is such that the shift of amount can be detected on basis of the correlation coefficients. Thus a number of data that is required for the correlation calculation is obtained and the accuracy in the detection of the amount of shift is improved. In other words, too small number of the comparison data causes a danger that error detection may be performed with misrecognition of characteristics of waveforms of the output waveform signals. Besides, the size of the whole area of the light receiver (i.e., a range from which outputs from the light receiver are recorded) is larger than the predetermined moving amount of the detection object, so that a moving amount can be detected on basis of the correlated calculation. In addition, the size of the light receiver can be set at a minimum value.

In an embodiment of the optical moving amount detecting device, the size of the whole area of the light receiver is equal to a sum of the size of the first partial area, the moving amount of the image of the linear reflected beam which amount corresponds to the predetermined moving amount of the detection object, and a predicted amount of positional shift of the detection object from the moving amount. In the case that the optical moving amount detecting device of the invention is used for equipment such as printer that conveys a detection object (a paper form) and performs processing on the object, the predetermined moving amount of the detection object refers to a feed of the detection object in a conveying section of the equipment which feed has been preset according to a size of the detection object, a position for the processing on the detection object, and the like. The predicted amount of positional shift of the detection object refers to a maximum amount of positional shift of the image of the linear reflected beam which amount corresponds to a maximum amount of error of the feed that commonly occurs in the conveying section of the equipment.

In accordance with the optical moving amount detecting device of the embodiment, the size of the whole area of the light receiver can be set at a minimum size. Besides, photodetectors in both end parts of the light receiver can be used for the detection of the amount of shift and photodetectors in middle part of the light receiver may be omitted. Thus a decrease in number of the data facilitates data processing and a decrease in number of the photodetectors allows the device to be inexpensive.

The electronic equipment of the present invention comprises the optical moving amount detecting device of said invention.

In accordance with the electronic equipment of the invention, a position of an object (detection object) in and out of the electronic equipment can be measured accurately by the optical moving amount detecting device.

The conveyance processing system of the present invention comprises:

the optical moving amount detecting device of said invention,

a conveying section for conveying the detection object,

a processing section for performing specified processing for the detection object, and

a controller for controlling the conveying section so as to align with a target position a position of the detection object after conveyance, on basis of a moving amount of the detection object that is detected by the optical moving amount detecting device.

In accordance with the conveyance processing system of the invention, the position of the detection object is accurately detected, and the positional shift of the detection object is automatically corrected on condition that the detection object is not in the specified position. Thus the specified processing can be performed in correct positions on the detection object.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a configuration illustrating a first embodiment of an optical moving amount detecting device of the invention;

FIG. 2 is a plan view illustrating an image of a linear beam that is formed on a detection object;

FIG. 3 is a plan view illustrating a light receiver formed of a plurality of photodetectors;

FIG. 4 is an explanatory diagram illustrating output data from the photodetectors;

FIGS. 5A-5B explanatory diagrams illustrating a method of detecting a moving amount of the detection object;

FIGS. 6A-6B explanatory diagrams illustrating output values before and after movement of the detection object;

FIG. 7 is a configuration illustrating a second embodiment of an optical moving amount detecting device of the invention;

FIG. 8 is an explanatory diagram illustrating an intensity distribution of a linear beam;

FIGS. 9A-9C explanatory diagrams illustrating a principle of detection of an amount of shift;

FIG. 10 is an explanatory diagram illustrating detection of amount of shift on basis of correlated calculation;

FIG. 11 is a plan view illustrating another embodiment of a light receiver;

FIG. 12 is a configuration illustrating a first embodiment of a conveyance processing system of the invention;

FIG. 13 is a flow chart illustrating a flow of the conveyance processing system;

FIG. 14 is an explanatory diagram illustrating a speckle pattern; and

FIG. 15 is a configuration illustrating a conventional moving amount detecting device.

### DETAILED DESCRIPTION OF THE PREFERRED EMBODIMENTS

Hereinbelow, the present invention will be described in detail with reference to preferred embodiments shown in the accompanying drawings.

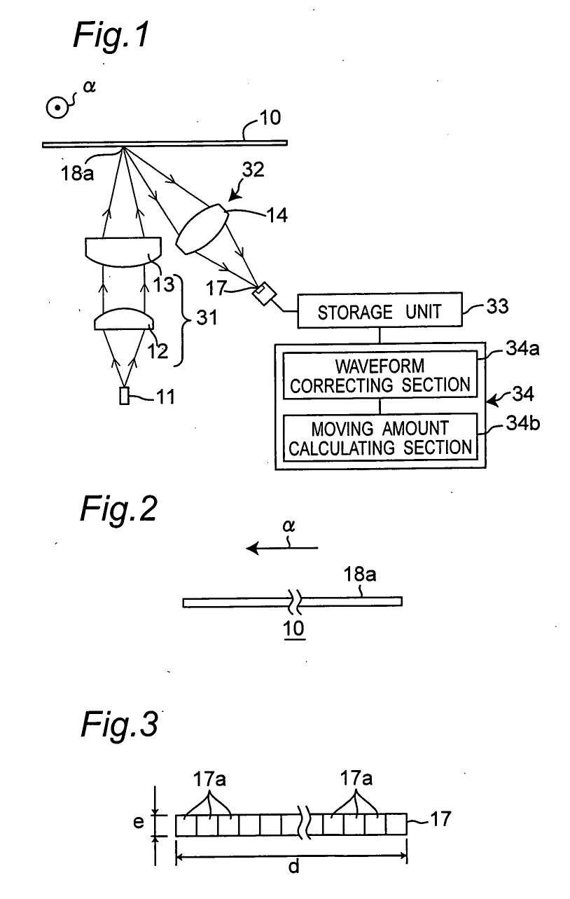

FIG. 1 shows a configuration of an embodiment of an optical moving amount detecting device of the invention. The moving amount detecting device detects a moving amount of a detection object 10 between a first time point and a second time point and has a light emitter 11, a light receiver 17, a first optical system 31 for making light from the light emitter 11 into a linear beam extending in parallel with a direction of the movement of the detection object 10 and casting the beam on the detection object 10, a second optical system 32 by which a linear reflected beam that is the linear beam reflected from the detection object 10 is made incident on the light receiver 17, a storage unit 33 for storing first output waveform signals from the light receiver 17 at the first time point and second output waveform signals from the light receiver 17 at the second time point, and a moving amount detecting unit 34 for detecting an amount of shift between the first output waveform signals and the second output waveform signals in a longitudinal direction of the linear reflected beams and detecting the moving amount of the detection object 10 on basis of the amount of shift.

The light emitter 11 is preferably composed of a plurality of semiconductor laser devices disposed linearly, so that light from the light emitter 11 can be shaped linearly.

The first optical system 31 is composed of a collimating lens 12 and a cylindrical lens 13. The system collimates light from the light emitter 11 by the collimating lens 12, passes the light through the cylindrical lens 13, thereafter makes the light into a linear beam extending in parallel with the direction of the movement of the detection object 10, and casts the beam on the detection object 10. Then an image 18a of the linear beam having a predetermined length is formed along the direction of the movement of the detection object 10 on a surface of the detection object 10. In FIG. 1, the detection object 10 moves from back side to front side as shown by an arrow α. A cylindrical lens may be substituted for the collimating lens 12 and, in that case, light from the light emitter 11 is converged on only one side.

The second optical system 32 is composed of a receiving lens 14, and (part or all of) reflected light from the image 18a of the linear beam on the detection object 10 is made into the linear reflected beam and made incident on the light receiver 17 by the receiving lens 14.

As shown in FIG. 2, the image 18a of the linear beam is formed in parallel with the direction of the movement of the detection object 10 which direction is shown by the arrow α. A length of the image is set at several millimeters and a width thereof is set at tens of micrometers. A light intensity distribution of the linear beam with respect to a longitudinal direction thereof is preferably uniform.

As shown in FIG. 3, the light receiver (line sensor) 17 is composed of a plurality of photodetectors 17a that are linearly disposed corresponding to the image of the linear reflected beam. A length d is set at several millimeters and a width e is set at tens of micrometers. Each of the photodetectors 17a generates an output value and is preferably formed of a photodiode (PD) or may be formed of one-dimensional CCD, C-MOS or the like.

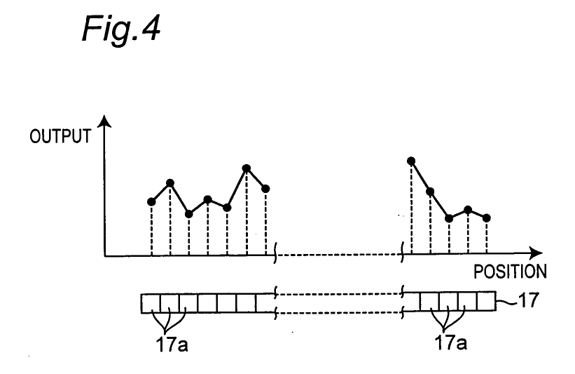

Output values that are outputted from the photodetectors 17a receiving the linear reflected beam vary with surface conditions (unevenness of the surface) of the detection object 10, as shown in FIG. 4, for example. The plurality of output values are formed into the first output waveform signals and the second output waveform signals that represent output distributions of the linear reflected beams with respect to the longitudinal direction thereof.

The first output waveform signals are formed of output values from the photodetectors 17a having received reflected light from the detection object 10 (that is stationary) at the first time point. The second output waveform signals are formed of output values from the photodetectors 17a having received reflected light afresh from the detection object 10 (that is stationary) at the second time point. The detection object 10 is preferably measured while being stationary at least at the second time point, and thus the detection object 10 can be set in an accurate position. The second output waveform signals are such that the first output waveform signals are shifted in the direction of the movement of the detection object 10.

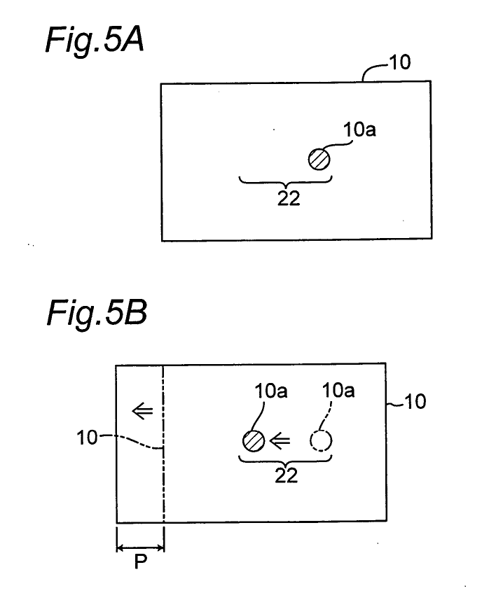

As shown in FIG. 5A, specifically, light from a specified area 10a on the detection object 10 is received at the first time point by a whole area 22 of the light receiver 17 corresponding to the image of the linear reflected beam. As shown in FIG. 5B, movement of the detection object 10 by a given pitch P from the first time point (shown by imaginary lines) to the second time point results in movement of the specified area 10a thereon by the given pitch P from status shown by the imaginary lines to status shown by solid lines. At the second time point, light from the specified area 10a after the movement is still within the whole area 22 of the light receiver 17.

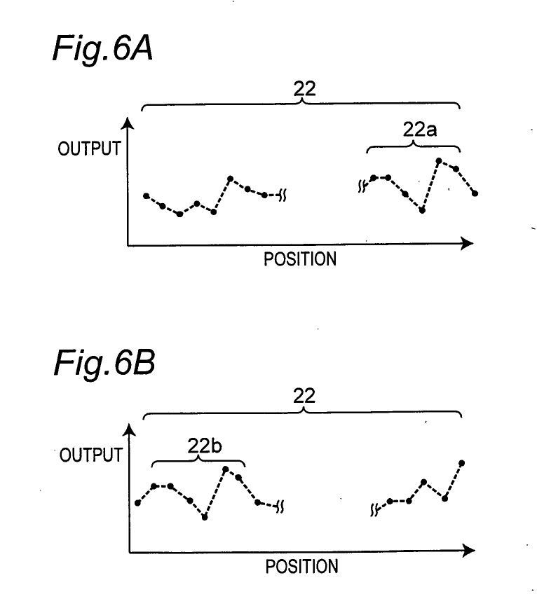

FIGS. 6A-6B are diagrams illustrating output values from the photodetectors 17a in the whole area 22 of the light receiver 17 before and after movement of the detection object 10. As shown in FIG. 6A, light from the specified area 10a at the first time point is received by a first partial area 22a of the light receiver 17. As shown in FIG. 6B, on the other hand, light from the specified area 10a at the second time point is received by a second partial area 22a of the light receiver 17. Thus output values generally identical to those from the first partial area 22a appear in the second partial area 22b. A shift between the first partial area 22a and the second partial area 22b is calculated on basis of positions of the photodetectors 17a, and a moving amount is thereby detected.

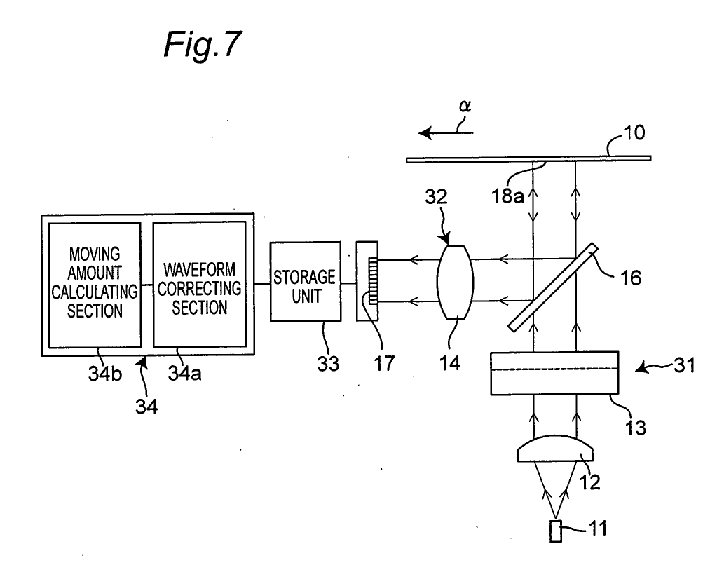

FIG. 7 shows another embodiment of the invention in which a deflector 16 for deflecting a linear reflected beam from a detection object 10 is provided between a first optical system 31 and the detection object 10. Specifically, a beam splitter 16 as the deflector is provided between a cylindrical lens 13 and the detection object 10, and the light emitter 11 and the light receiver 17 are therefore prevented from overlapping each other on condition that an optical axis of light cast on the detection object 10 and an optical axis of light reflected from the detection object 10 are identical. Thus the optical axes on casting side and on reflection side are identical, so that an output of the reflected light can easily be gained. With the optical axes generally perpendicular to a moving direction of the detection object 10, further improvement in the output of the reflected light and in detection accuracy and miniaturization of the device can be achieved. Diffraction grating may be used as the deflector 16.

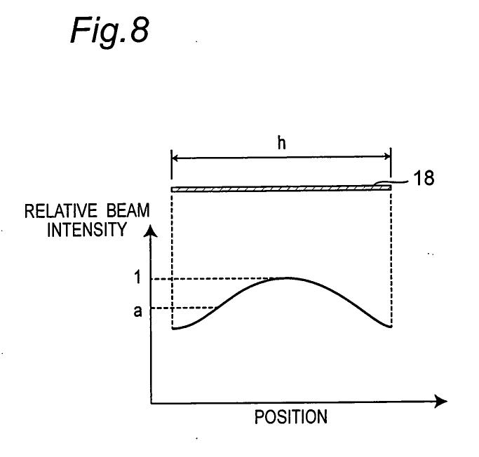

As shown in FIGS. 1 and 7, the moving amount detecting unit 34 has a waveform correcting section 34a. On condition that a light intensity distribution of the linear beam 18 with respect to directions of a length h of the beam is not uniform as shown in FIG. 8, for example, the waveform correcting section 34a multiplies parts of the first output waveform signals and the second output waveform signals by a plurality of coefficients according to the light intensity distribution and thus corrects the light intensity distribution of the linear beam with respect to the directions of the length. Thus a difference is decreased between data (the first output waveform signals) before the movement and data (the second output waveform signals) after the movement both of which correspond to the same position on the detection object 10, and the detection accuracy is improved. The outputs may be corrected by variation in amplification factors of the photodetectors 17a.

As shown in FIGS. 1 and 7, the moving amount detecting unit 34 has a moving amount calculating section 34b. The moving amount calculating section 34b determines correlation coefficients between first output waveform partial signals that are outputted at the first time point from the first partial area 22a corresponding to part of the image of the linear reflected beam on the light receiver 17 with respect to the directions of the length and a plurality of sets of second output waveform partial signals that are outputted at the second time point from a plurality of partial areas corresponding to a plurality of parts of the image of the linear reflected beam on the light receiver 17. The moving amount calculating section 34b then determines a second partial area 22b that results in the highest correlation coefficient at the second time point, and calculates a moving amount of the detection object 10 on basis of an amount of shift between the first partial area 22a and the second partial area 22b.

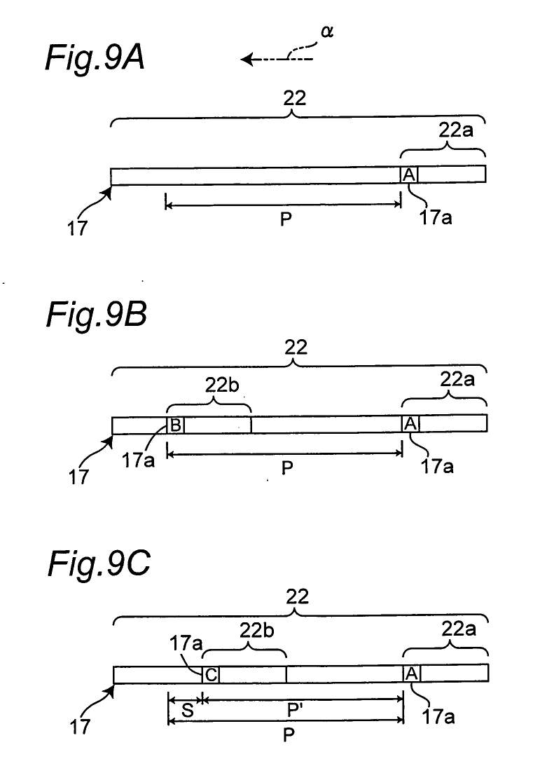

A method in which the moving amount calculating section 34b detects the moving amount will be described with reference to FIGS. 9A-9C.

At the first time point, as shown in FIG. 9A, output data from the first partial area 22a of the light receiver 17 is stored as first comparison data into the storage unit 33. The first partial area 22a is formed of photodetectors 17a ranging from a specified position A to a right end in the light emitter 17. The detection object 10 moves in a direction of an arrow α shown by an imaginary line.

At the second time point when the detection object 10 has moved by the given pitch P, as shown in FIG. 9B, the first comparison data is detected from the second partial area 22b of the light receiver 17. That is, the data of the specified position A is then obtained from a photodetector in a specified position B. In a correlated calculation executed by the moving amount detecting unit 34 between output values from the photodetectors 17a in FIG. 9B and the first comparison data, specifically, the data of the specified position A exhibits the highest correlation with data from the specified position B. In short, the second partial area 22b that generates output values generally the same as the first comparison data can be determined with use of correlation coefficients. An amount of shift between the specified position A (the first partial area 22a) and the specified position B (the second partial area 22b), that is, the given pitch P makes the moving amount of the detection object 10.

Provided that data from the first partial area 22a ranging from the specified position A to the right end is stored as second comparison data into the storage unit 33 apart from the correlated calculation, as shown in FIG. 9B, a moving amount can be detected in succession. As shown in FIG. 9C, for example, a correlated calculation between output values from the photodetectors 17a and the second comparison data may prove that the data of the specified position A is obtained from a photodetector 17a in a specified position C. FIG. 9C shows status in which the detection object 10 has been shifted from a target position of the given pitch P. An actual moving amount P′ at this point is equal to a value obtained by subtraction of an amount S of the positional shift from the given pitch P.

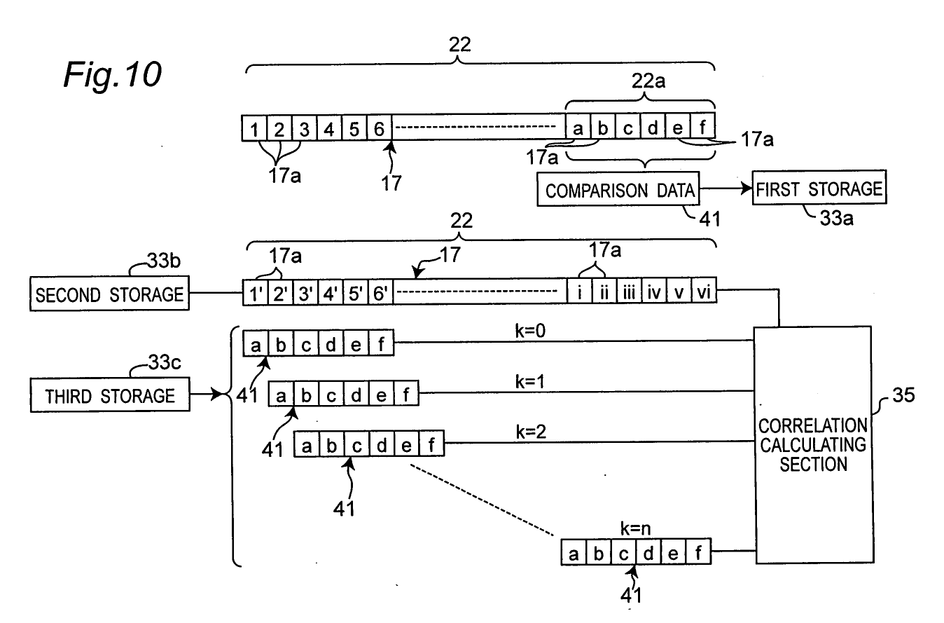

Hereinbelow, the correlated calculation will be described with reference to FIG. 10.

A correlation coefficient ρ (−1≦ρ≦1) is an index representing a similarity between a sample group Xi and a sample group Yi and is represented by a following expression (1):

$$ρ = \frac{{\sum }_{i = 1}^{n} ( {x}_{i} - \overline{x} ) ( {y}_{i} - \overline{y} )}{\sqrt{{\sum }_{i = 1}^{n} {( {x}_{i} - \overline{x} )}^{2}} \sqrt{{\sum }_{i = 1}^{n} {( {y}_{i} - \overline{y} )}^{2}}} \qquad ( 1 )$$

A comparison data row (a, . . . , f) corresponding to the first partial area 22a in an output data row (1, 2, . . . , e, f) from the photodetectors 17a in the whole area 22 of the light receiver 17 is stored as comparison data 41 into a first storage 33a, and then correlation coefficients between the comparison data 41 and an output data row (1′, 2′, . . . , v, vi) stored from the whole area 22 of the light receiver 17 into a second storage 33b after movement of the detection object 10 are calculated in a correlation calculating section 35. The first storage 33a, the second storage 33b, and a third storage 33c re included in the storage unit 33, and the correlation calculating section 35 is included in the moving amount calculating section 34b.

Specifically, the correlation coefficients are determined with the comparison data 41 shifted one by one (k=0, 1, 2, . . . , n) in a direction of the length of the light receiver 17, and then the correlation coefficients are maximized in a position where the similarity is the greatest. A value k (a number of shifts) that results in the maximization is multiplied by a size of one photodetector 17a (a photodetector pitch multiplied by k), and then a position of the comparison data 41 after the movement can be determined and a moving amount can be detected.

Even if the photodetector 17a has a large size, a resolving power can be improved with a change in image magnification of the receiving lens 14.

A size of the first partial area 22a of the light receiver 17 is such that the first output waveform partial signals outputted from the first partial area 22a can be discriminated from signals outputted at the first time point from areas other than the first partial area 22a in the light receiver 17. That is, a number of output values (a number of comparison data) from the first partial area 22a is such that only one area can be determined as the second partial area 22b on basis of the correlation coefficients.

On a premise that the detection object 10 is conveyed by a predetermined moving amount, a size of the whole area 22 of the light receiver 17 (a range from which the output values are recorded) is not smaller than a sum of the size of the first partial area 22a (the number of the comparison data) and a moving amount (preset moving amount) of the image of the linear reflected beam which amount corresponds to the predetermined moving amount of the detection object 10. That is, recording range≧(preset moving amount+number of comparison data). More strictly, the size of the whole area 22 of the light receiver 17 is equal to a sum of the size of the first partial area 22a, the preset moving amount, and a predicted amount of positional shift (a predicted positional shift amount) of the detection object 10 from the preset moving amount. The predicted positional shift amount refers to an amount of positional shift of the image of the linear reflected beam which amount corresponds to an amount of positional shift of the detection object 10 that is predicted from the preset moving amount of the detection object 10.

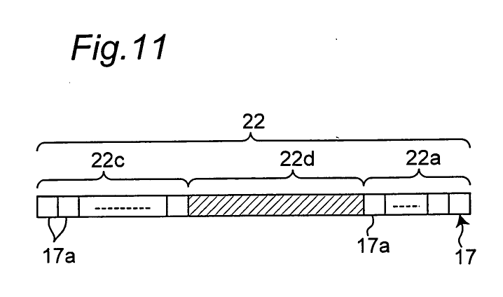

Provided that the preset moving amount, the number of the photodetectors 17a in the first partial area 22a (the number of output values of the comparison data), and the predicted positional shift amount are known, a size of a downstream (left) end part 22c of the light receiver 17 may be a sum of the size of the first partial area 22a and the predicted positional shift amount, as shown in FIG. 11. That is, a number of photodetectors 17a in the end part 22c is a sum of the number of the photodetectors 17a in the first partial area 22a and a number of photodetectors 17a that is converted from the predicted positional shift amount. Accordingly, an unwanted part 22d where any photodetectors 17a are not provided may be provided between the end part 22c and the first partial area 22a that makes an upstream (right) end part in the whole area 22. Thus the number of the photodetectors 17a can be decreased and cost reduction can be achieved.

In accordance with the optical moving amount detecting device of the invention that is configured as described above, a moving amount of a detection object 10 that has comparatively smooth surfaces can be detected accurately. The moving amount detecting device can be made small in shape and inexpensive because the device is composed of a comparatively small number of components and because the device can perform signal processing more easily than the moving amount detecting devices described above do.

In accordance with electronic equipment having the optical moving amount detecting device, a moving amount of an object in and out of the electronic equipment can be detected accurately by the optical moving amount detecting device. On condition that the electronic equipment is equipment such as printer, i.e., electronic equipment that sequentially and repetitively carries out steps of conveyance, stoppage, process, and the like for an object (such as paper form), a conveyance processing system that is capable of performing specified processing for correct positions on the object (detection object) is provided by use of the optical moving amount detecting device of the invention.

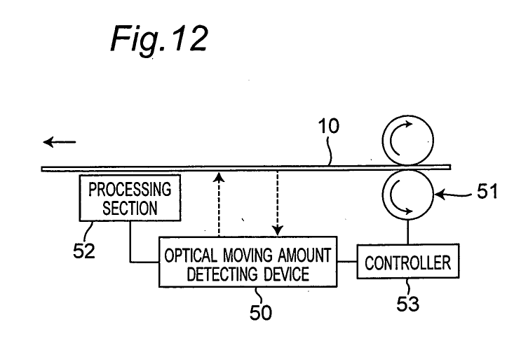

As shown in FIG. 12, the conveyance processing system has the optical moving amount detecting device 50, a conveying section 51 (composed of rollers or the like) for conveying a detection object 10, a processing section 52 for performing specified processing for the detection object 10, and a controller 53 for controlling the conveying section 51 so as to align with a target position a position of the detection object 10 after the conveyance, on basis of a moving amount of the detection object 10 that is detected by the optical moving amount detecting device 50.

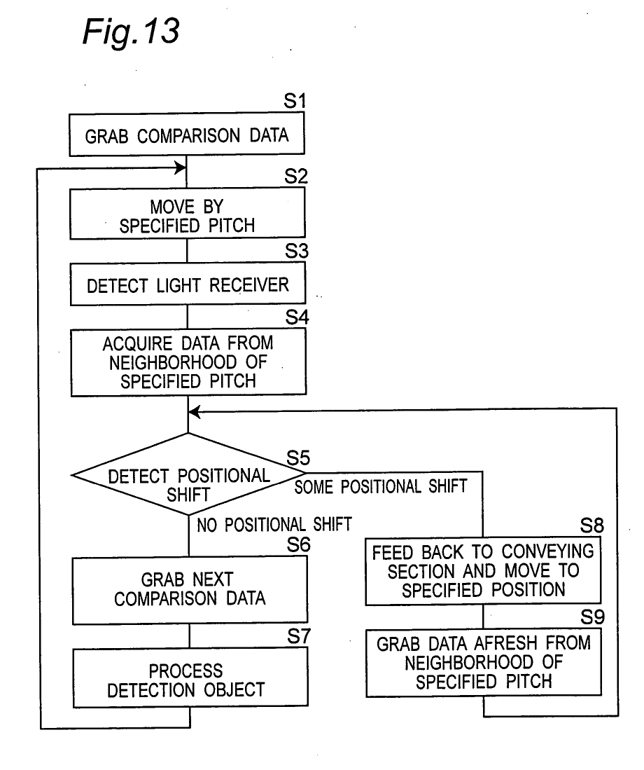

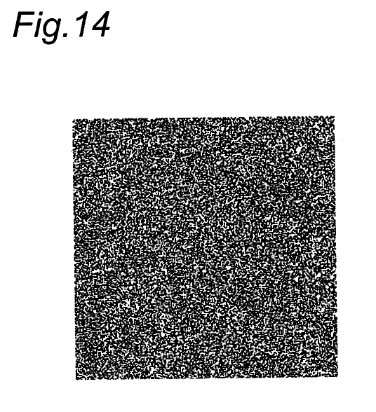

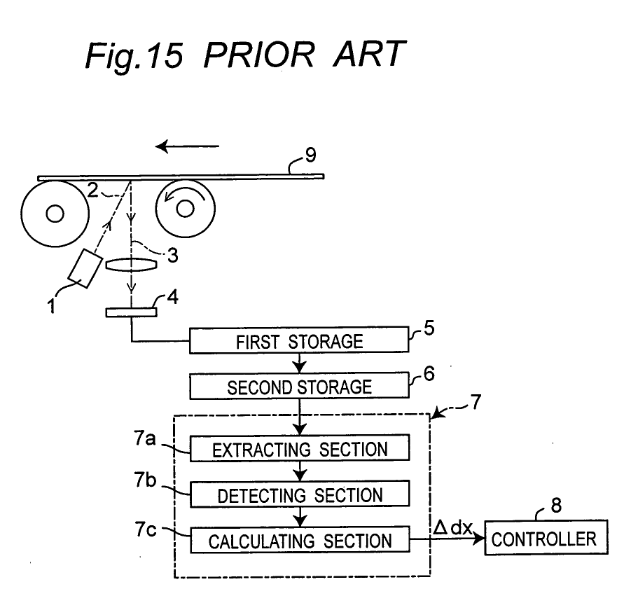

FIG. 13 shows a flow chart concerning the conveyance processing system. Initially, the comparison data from the first partial area 22a is grabbed as shown in FIG. 9A (step S1). Subsequently, the detection object 10 is conveyed by a specified pitch (step S2). At this point, positions on the detection object 10 (conveyance object) from which the comparison data has been grabbed have moved to positions forwarded by the specified pitch on condition that there has been no positional shift. Therefore, data from neighborhood of the latter positions is acquired by the light receiver (steps S3, S4) and the positional shift is detected (step S5).

If there is no positional shift, next comparison data is grabbed as shown in FIG. 9B (step S6). If there is any positional shift, on the other hand, an amount of the positional shift is fed back to the conveying section and the detection object is moved to a correct position (step S8).

After that, data is grabbed afresh from the neighborhood of the specified pitch (step S9) and whether the object has moved by the specified pitch or not is detected (step S5). If there is no positional shift, next comparison data is grabbed (step S6) and processing is performed on the detection object 10 (step S7). The processing refers to printing in a printer, for example. In electronic equipment such as printer that performs printing, specified printing processes thus can be effected in specified positions and high-definition printing can be achieved.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. An optical moving amount detecting device comprising:
a light emitter,
a light receiver,
a first optical system for making light from the light emitter into a linear beam having a length and a width, the length extending in parallel with a direction of movement of a detection object and casting the linear beam on the detection object,
a second optical system by which a linear reflected beam that is the linear beam reflected from the detection object is made incident on the light receiver,
a storage unit for storing first output waveform signals that are outputted from the light receiver receiving the linear reflected beam at a first time point and that represent an output distribution of the linear reflected beam along a longitudinal direction thereof and storing second output waveform signals that are outputted from the light receiver receiving the linear reflected beam at a second time point and that represent an output distribution of the linear reflected beam along the longitudinal direction thereof, and
a moving amount detecting unit for detecting an amount of shift between the first output waveform signals and the second output waveform signals in the longitudinal direction of the linear reflected beams and detecting a moving amount of the detection object on basis of the amount of shift.

2. An optical moving amount detecting device as claimed in claim 1, wherein the light emitter is composed of a plurality of semiconductor laser devices disposed linearly.

3. An optical moving amount detecting device as claimed in claim 1, wherein a deflector for deflecting the linear reflected beam from the detection object is provided between the first optical system and the detection object.

4. An optical moving amount detecting device as claimed in claim 1, wherein the moving amount detecting unit comprises a waveform correcting section for multiplying parts of the first output waveform signals and of the second output waveform signals by a plurality of coefficients according to a light intensity distribution of the linear beam with respect to a longitudinal direction of the linear beams and thus correcting the light intensity distribution of the linear beam with respect to the longitudinal direction.

5. An optical moving amount detecting device as claimed in claim 1, wherein the moving amount detecting unit comprises a moving amount calculating section for determining correlation coefficients between first output waveform partial signals that are outputted at the first time point from a first partial area corresponding to part of an image of the linear reflected beam on the light receiver with respect to the longitudinal direction and a plurality of sets of second output waveform partial signals that are outputted at the second time point from a plurality of partial areas corresponding to a plurality of parts of an image of the linear reflected beam on the light receiver, determining a second partial area that results in a highest correlation coefficient at the second time point, and calculating the moving amount of the detection object on basis of an amount of shift between the first partial area and the second partial area.

6. An optical moving amount detecting device as claimed in claim 5, wherein a size of the first partial area of the light receiver is such that the first output waveform partial signals outputted from the first partial area can be discriminated from signals outputted at the first time point from areas other than the first partial area in the light receiver and wherein a size of a whole area of the light receiver is not smaller than a sum of the size of the first partial area and of a moving amount of an image of the linear reflected beam which amount corresponds to a predetermined moving amount of the detection object.

7. An optical moving amount detecting device as claimed in claim 5, wherein the size of the whole area of the light receiver is equal to a sum of the size of the first partial area, the moving amount of the image of the linear reflected beam which amount corresponds to the predetermined moving amount of the detection object, and a predicted amount of positional shift of the detection object from the moving amount.

8. Electronic equipment comprising the optical moving amount detecting device as claimed in claim 1.

9. A conveyance processing system comprising:
the optical moving amount detecting device as claimed in claim 1,
a conveying section for conveying the detection object,
a processing section for performing specified processing for the detection object, and
a controller for controlling the conveying section so as to align with a target position a position of the detection object after conveyance, on basis of a moving amount of the detection object that is detected by the optical moving amount detecting device.

10. An optical movement detector for detecting movement of a detection object comprising:
a light emitter,
a first optical system projecting a light beam having a cross section having a length and a width on the detection object such that the length extends parallel to a direction of movement of the detection object,
a light receiver receiving a reflection of the light beam from the detection object,
a storage unit for storing first output waveform signals from the light receiver at a first time and storing second output waveform signals from the light receiver at a second time, and
a movement detecting unit for detecting an amount of shift between the first output waveform signals and the second output waveform signals and determining a movement amount of the detection object based on the detected amount of shift.

11. A method of optically detecting an amount of movement of an object comprising the steps of:
projecting light against the object to form a generally rectangular image having a length and a width such that the length is aligned with a direction of movement of the object;
detecting a first reflection of the generally rectangular image from the object at a first time and outputting first waveform signals related to the first detected reflection;
detecting a second reflection of the generally rectangular image from the object at a second time and outputting second waveform signals related to the second detected reflection;
measuring an amount of waveform shift between the first output waveform signals and the second output waveform signals, and
determining from the amount of waveform shift between the first output waveform signals and the second output waveform signals an amount of object shift between the first time and the second time.

12. The method of claim 11 including the additional step of deflecting the first reflection of the generally rectangular image.

13. The method of claim 11 including the additional steps of:
multiplying a part of the first output waveform signals and a part of the second output waveform signals by a plurality of coefficients according to a light intensity distribution of the linear beam with respect to a longitudinal direction of the linear beam, and
correcting the light intensity distribution of the linear beam with respect to the longitudinal direction.

14. The method of claim 11 including the additional steps of:
determining correlation coefficients between first output waveform partial signals outputted at the first time point from a first partial area corresponding to a part of the reflected image of the linear beam with respect to the longitudinal direction and a plurality of sets of second output waveform partial signals outputted at the second time from a plurality of partial areas corresponding to a plurality of parts of the image of the linear beam,
determining a second partial area from the plurality of partial areas that results in a highest correlation coefficient at the second time, and
calculating the amount of movement of the object based on the shift between the first partial area and the second partial area.
